(19) United States
(12) Patent Application Publication
(10) Pub. No.: US 2003/0145444 A1
(43) Pub. Date: Aug. 7, 2003

(54) Fabric and method for the manufacture thereof

(75) Inventor: Justus Schmitz, Emsdetten (DE)

Correspondence Address: BROWDY AND NEIMARK, P.L.L.C., 624 NINTH STREET, NW, SUITE 300, WASHINGTON, DC, 20001-5303, US

(73) Assignee: Schmitz-Werke BmbH & Co.KG, Emsdetten (DE)

(21) Appl. No.: 10/356,762

(22) Filed: Feb. 3, 2003

(30) Foreign Application Priority Data
Feb. 1, 2002 (DE) 102 04 148.2

(51) Int. Cl. C08G 73/10; D06H 7/00

(52) U.S. Cl. 28/170

(57) ABSTRACT

With regard to a fabric comprising openings, it is provided that said openings are created afterwards by perforation including the cutting of fabric threads, e.g. by punching or laser welding of the fabric threads, e.g. by means of needles, and, if necessary, the stabilization of the cut or displaced fabric threads.

### BACKGROUND OF THE INVENTION

1. Field of the Invention

The present invention relates to a fabric comprising openings and a method for the manufacture thereof.

2. Background Art

Fabrics comprising openings are known, for example, as curtain textiles. The respective openings are formed during the manufacturing of the fabric, that is, during the weaving process. Fabrics of this type, such as curtain textiles, are intended for indoor use and, due to their durability features, would be unsuitable for outdoor use.

Weatherproof textiles for outdoor use conventionally lack such openings and provide for a certain transparency only due to the fact that the fabric is made having a relatively rough texture or that the yarns used are more or less transparent.

It is known from DE 1 535 440 A and DE 28 34 873 A1 to create openings in a fabric after the weaving process by displacing the weft and/or warp threads for example by having needles or pins penetrate the fabric length at desired distances without damaging the threads of the fabric.

DE 2 040 002 A teaches an apparatus for punching stacked textile layers in order to form the peripheral contour.

### SUMMARY OF THE INVENTION

It is an object of the invention to provide a stable, weatherproof fabric to be used for conservatory shades, vertical sun blinds, window awnings and the like, wherein said fabric reduces the intensity of incidental sunlight to a predetermined level while on the other hand maintaining a level of transparency sufficient for the convenience of human beings.

According to the invention, this object is achieved by creating the openings after the weaving process by way of perforation including the cutting of fabric threads and, if necessary, stabilizing the cut or displaced fabric threads. With such a fabric, it is possible to create openings of nearly any size, density and geometry or structure irrespective of the design and the geometry of the fabric.

If the openings were provided by punching, it is possible by heating and an appropriate choice of the punching needle geometry to have the yarns melting on or sintering together at the punching edge due to the pressure and temperature applied during the punching process. Hereby, a practically automatic stabilization of the edges of the perforations created by punching is achieved. This applies in particular to the case of using synthetic yarns such as polyester, polypropylene, polyethylene, polyamide, polyvinylchloride or polyacryl. In case of using coated yarns, the coating provides additional mechanical stabilization to the yarns. Melting-on of the opening edges and coating increase the dimensional stability of the openings, but are often not required necessarily.

Further, the invention relates to a method for manufacturing such a fabric wherein said fabric is firstly produced by weaving in a conventional manner, and thereafter provided with perforations, especially by punching or laser cutting. Preferably, thermoplastic yarns are used in order to achieve a stabilization by melting-on or sintering during the process of punching or laser cutting.

Now the invention will be described with a view to a preferred exemplary embodiment with reference to the drawings:

### BRIEF DESCRIPTION OF THE DRAWINGS

FIG. 1 schematically illustrates the creation of the openings by punching; and

FIG. 2 schematically illustrates the creation of the openings by punching and melting-on the edges.

### DESCRIPTION OF THE PREFERRED EMBODIMENT

The perforations of a fabric in accordance with the invention comprise a circular configuration having a size between 0.5 and 3 mm.

The density is selected such as the free cross-sectional area of the openings accounts for 1 and 30% of the fabric surface.

In the exemplary embodiment, a spinneret-colored polyacryl yarn having a titer of Nm 34/2, a core density of 30 threads/cm, and a weft density of 15 threads/cm is used as a fabric.

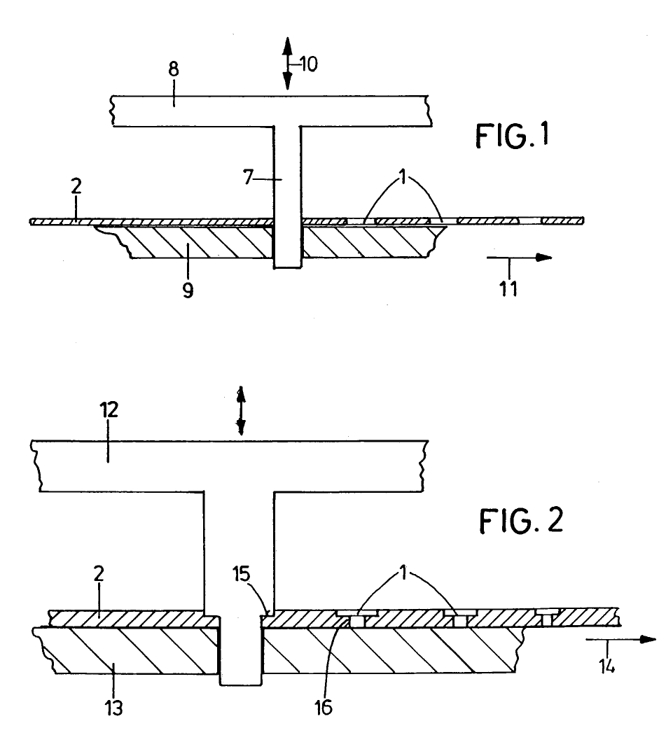

In the embodiment shown in FIG. 1, a punching tool 7 is provided, comprising an upper part 8 in the shape of a male mould and a lower part 9 in the shape of a female mould, wherein said upper part 8 performs a rising and lowering movement in the direction indicated by the arrow 10 so that, when the fabric advances in the direction indicated by the arrow 11, again openings 1 are created by cutting the fabric threads.

In the embodiment shown in FIG. 2, a punching tool is provided, comprising an upper part 12 and a lower part 13, which the fabric 2 is passed along in the direction indicated by the arrow 14, wherein said upper part 12, in a portion of the front end of the actual punching tool, comprises an annular collar 15 which generates a densification zone 16 surrounding said openings 1, wherein, in addition to this mechanical densification, pre-heating of the fabric and/or heating of said upper part 12 is provided.

What is claimed is:

1. A fabric (2) comprising openings (1), wherein said openings (1) are created afterwards by perforation including the cutting of fabric threads by punching or laser welding and, if necessary, stabilizing the cut or displaced fabric threads.

2. A fabric (2) according to claim 1, wherein said openings (1) are created by punching, the yarns being selected so that, due to the pressure and temperature applied during the punching process, said yarns melt on or sinter together at the punching edge.

3. A method for manufacturing a fabric (2) comprising openings (2), wherein said fabric (2) is produced by weaving in a conventional manner and only afterwards provided with perforations.

4. A method according to claim 3, wherein said perforations are created by punching or laser-cutting.

5. A method according to claim 4, wherein said perforations created during the punching or laser-cutting process are stabilized by melting-on or sintering together the cut yarns.
